(19) United States
(12) Patent Application Publication
(10) Pub. No.: US 2005/0209750 A1
(43) Pub. Date: Sep. 22, 2005

(54) Apparatus and method of roll control for vehicle

(76) Inventors: Tatsuya Masamura, Tokyo (JP); Shinichi Hagidaira, Tokyo (JP)

Correspondence Address: RABIN & BERDO, P.C., Suite 500, 1101 14th Street, N.W., Washington, DC, 20005, US

(21) Appl. No.: 11/074,019

(22) Filed: Mar. 8, 2005

(30) Foreign Application Priority Data
Mar. 19, 2004 (JP) 2004-080113

(51) Int. Cl. B60R 21/00

(52) U.S. Cl. 701/38; 180/282; 280/5.502

(57) ABSTRACT

at least two lateral acceleration sensors (21) (22) located at different positions of a vehicle body (100) to detect lateral acceleration acting on the vehicle body; and

a calculator (50) to separate and calculate actual lateral acceleration (GL) acting on the vehicle body by a centrifugal force, and roll angular acceleration (φ) acting on the vehicle body around the roll center, based upon a distance (La, Lb) from a roll center of the vehicle body to each of the sensors, an intersection angle (θa, θb) of each line connecting each of the sensors and the roll center, and outputs (GLa, GLb) of the sensors are provided.

### BACKGROUND OF THE INVENTION

1. Field of the Invention

The present invention relates to a detection apparatus and a detection method of a roll control signal for a vehicle, and an apparatus of controlling roll of a vehicle based upon the roll control signal.

2. The Related Art of the Invention

In regard to a roll control for a vehicle, Japanese Unexamined Patent Publication No. 9-123729 or Japanese Unexamined Patent Publication No. 11-263113 has disclosed that a lateral acceleration sensor in addition to a vehicle speed sensor and a steering angle sensor is attached to a vehicle body where the lateral acceleration outputted from the lateral acceleration sensor is weighted or corrected, thus controlling the roll of the vehicle body.

### SUMMARY OF THE INVENTION

The lateral acceleration sensor is required to be attached to a roll center of the vehicle body in order to accurately detect lateral acceleration (actual lateral acceleration) acting on the vehicle body by a centrifugal force. However, it is in fact difficult to attach the lateral acceleration sensor to the roll center of the vehicle body for reason that there is a case where the roll center is positioned lower than the vehicle body or a position of the roll center changes with a roll angle of the vehicle body.

As a result, a detection value outputted from the lateral acceleration sensor at the time of the steering of the steering wheel includes mixing of an actual lateral acceleration component generated in the vehicle body and a roll angular acceleration component by the roll generated in the vehicle body.

And in a case where a roll control is performed using only a detection value outputted from the lateral acceleration sensor, when a vehicle is yawed caused by disturbances, such as the crosswind a vehicle receives when the vehicle goes straight, an actual roll direction of the vehicle body is in reverse to a direction of a detection value outputted from the lateral acceleration sensor because of the structure of the lateral acceleration sensor, possibly increasing the roll of the vehicle body further. And a switching steering of a steering wheel generates a time lag in the roll motion of the vehicle body to a change of the actual lateral acceleration. Accordingly, there is a case where the direction of the actual lateral acceleration as detected above is different from the actual roll direction of the vehicle body.

It is an object of the present invention to accurately extract an actual lateral acceleration by eliminating a roll angular acceleration component included in the output of a lateral acceleration sensor.

Furthermore it is another object of the present invention to improve a control performance in a roll control for a vehicle.

These and other objects, features, aspects and advantages of the present invention will become apparent to those skilled in the art from the following detailed description, which, taken in conjunction with the annexed drawings, discloses a preferred embodiment of the present invention.

To achieve above the objects the present invention provides a detection apparatus of a roll control signal for a vehicle. The detection apparatus comprises at least two lateral acceleration detectors located at different positions of a vehicle body to detect lateral acceleration acting on the vehicle body, and a calculator to separate and calculate actual lateral acceleration acting on the vehicle body by a centrifugal force, and roll angular acceleration acting on the vehicle body around the roll center based upon a distance from a roll center of the vehicle body to each of the detectors, an intersection angle of each line connecting each of the detectors and the roll center, and outputs of the detectors.

The present invention also provides a detection method of a roll control signal for a vehicle. The detection method comprises a steps of detecting lateral acceleration acting on a vehicle body from at least two lateral acceleration detectors located at different positions of the vehicle body, and calculating actual lateral acceleration acting on the vehicle body by a centrifugal force, and roll angular acceleration acting on the vehicle body around the roll center based upon a distance from a roll center of the vehicle body to each of the detectors, an intersection angle of each line connecting each of the detectors and the roll center, and outputs of the detectors.

The present invention also provides a stabilizer apparatus for controlling roll of a vehicle. The stabilizer apparatus comprises a torsion bar to connect a right and a left wheel of the vehicle, an actuator to provide a torsion force to the torsion bar by a hydraulic pressure, a hydraulic control device to control the hydraulic pressure supplied to the actuator, at least two lateral acceleration sensors disposed at different positions of a vehicle body to detect lateral acceleration acting on the vehicle body, a calculator to separate and calculate actual lateral acceleration acting on the vehicle body by a centrifugal force, and roll angular acceleration acting on the vehicle body around the roll center based upon a distance from a roll center of the vehicle body to each of the detectors, an intersection angle of each line connecting each of the detectors and the roll center, and outputs of the detectors, and a drive control device to control the hydraulic control device for restraining roll of the vehicle body based upon the actual lateral acceleration calculated by the calculator and the lateral acceleration.

### BRIEF DESCRIPTION OF THE DRAWINGS

The preferred embodiment according to the invention will be explained below referring to the drawings, wherein:

FIG. 1 is a view showing a stabilizer control apparatus in a preferred embodiment of the present invention;

FIG. 2 is a block diagram of a control apparatus;

FIG. 3 is a view showing an arrangement of lateral acceleration sensors;

FIG. 4 is a block diagram of a calculation process apparatus;

FIG. 5 is a view showing mounting positions of the lateral acceleration sensors;

FIG. 6 is a view showing different mounting positions of the lateral acceleration sensors; and

FIG. 7 is a view showing further different mounting positions of the lateral acceleration sensors.

### DETAILED DESCRIPTION OF THE PREFERRED EMBODIMENT

The selected embodiment of the present invention will now be explained with reference to the drawings. It will be apparent to those skilled in the art from this disclosure that the following description of the embodiment of the present invention is provided for illustration only, and not for the purpose of limiting the invention as defined by the appended claims and their equivalents.

The present embodiment is an embodiment where the present invention is applied to a roll control apparatus for a vehicle.

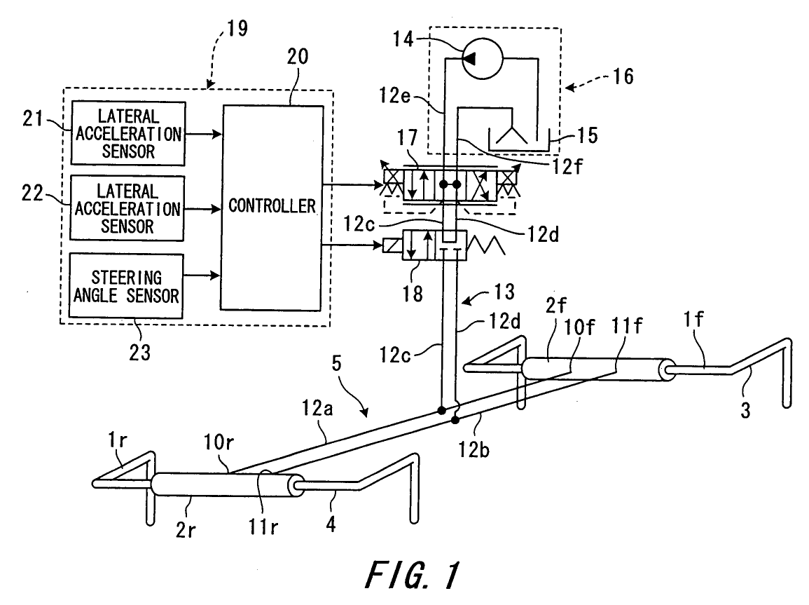

The roll control apparatus, as shown in FIG. 1, is provided with a stabilizer apparatus 5 equipped with a torsion bar to restrain roll of the vehicle body and a control apparatus 19 to control the stabilizer apparatus 5.

The stabilizer apparatus 5 is provided with a torsion bar 3 connecting a right and a left front wheel, a torsion bar 4 connecting under spring sides of a right and a left rear wheel, an actuator 2f to drive the torsion bar 3 in a side of the front wheels and an actuator 2r to drive the torsion bar 4 in a side of the rear wheels. These actuators 2f and 2r are constructed as a rotary actuator driven by a hydraulic pressure, each including a housing and a rotor defining two pressure chambers inside the housing where one of the housings is provided with ports 10f and 11f and the other is provided with ports 10r and 11r.

The stabilizer 1f for the front wheels composed of the torsion bar 3 and the actuator 2f is constructed by dividing the torsion bar 3 into two parts at the center thereof, and one of the divided parts is fixed to a housing side of the hydraulic rotary actuator in a side of the front wheels and the other is fixed to a rotary side of the hydraulic rotary actuator.

The stabilizer 1r for the rear wheels composed of the torsion bar 4 and the actuator 2r is constructed by dividing the torsion bar 4 into two parts at the center thereof, and one of the divided parts is fixed to a housing side of the hydraulic rotary actuator in a side of the rear wheels and the other is fixed to a rotary side of the hydraulic rotary actuator.

The actuator 2f in the side of the front wheels serves as an actuator for varying a torsion force to the stabilizer 1f for the front wheels, and the actuator 2r in the side of the rear wheels serves as an actuator for varying a torsion force to the stabilizer 1r for the rear wheels.

The port 10f and the port 10r for the actuators 2f and 2r are connected by a conduit 12a and the port 11f and the port 11r are connected by a conduit 12b. And these conduits 12a and 12b lead to a hydraulic source 16 constructed of a hydraulic pump 14 and a reservoir 15 via a hydraulic circuit 13.

The hydraulic circuit 13 is provided with conduits 12c and 12d connected respectively to the conduits 12a and 12b and conduits 12d and 12e connected respectively to the hydraulic pump 14 and the reservoir 15.

A pressure control valve 17 and a failsafe valve 18 are arranged in series in the half way of the hydraulic circuit 13. The fail safe valve 18, in the case of non-power supply state, maintains the hydraulic source 16 at an unloaded state and the conduits 12a and 12b at a blocked state and on the other hand, in the case of power supply state, communicates the conduits 12c and 12d with the conduits 12e and 12f.

The pressure control valve 17 is a pressure control valve of an electromagnetic type equipped with a solenoid and a passage of a pilot pressure, and in the case of the non-power supply, is in a neutral position by an urging spring to be held at the unloaded state for returning a pressurized oil from the hydraulic pump 14 back to the reservoir 15.

On the other hand, application of a control current to the solenoid of the pressure control valve 17 in the left side of FIG. 1 produces a pressure which corresponds to a solenoid current amount in the conduit 12c and maintains the conduit 12d at the unloaded state, and in contrast, application of the control current to the solenoid in the right side of FIG. 1 produces a pressure which corresponds to a solenoid current amount in the conduit 12d, and switches the conduit 12c to the unloaded state.

In regard to a roll control for a vehicle, a control apparatus 19 for controlling the pressure control valve 17 and the failsafe valve 18 is constructed of a controller 20, two lateral acceleration sensors 21, 22 as a detector detecting lateral acceleration acting on the vehicle body, and a steering angle sensor 23 detecting a steering angle.

Detection signals from the respective sensors 21, 22, and 23 are inputted to an input side of the controller 20 and a control signal is outputted respectively to the solenoid of the pressure control valve 17 and the solenoid of the failsafe valve 18 from an output side of the controller 20. The controller 20 controls operations of the pressure control valve 17 and the failsafe valve 18 in such a way that the controller 20 processes lateral acceleration signals outputted from each of the lateral acceleration sensors 21 and 22, and a steering angle signal outputted from the steering angle sensor 23 to produce a roll control signal, and applies the control current to each solenoid. A hydraulic pressure supplied to one of the pressure chambers in the actuators 2f and 2r is controlled to adjust a torsion force of each stabilizer 1f and 1r based upon the controls of the pressure control valve 17 and the failsafe valve 18.

Therefore, the controller 20, although not shown in FIGS in detail, is formed of a computer system including, for example an A/D converter to convert an analog voltage signal outputted from each of the sensors 21, 22, and 23 to a digital signal, a band pass filter to cut low frequency components and high frequency components, a CPU as a calculator, a memory apparatus such as a RAM and a ROM, a crystal oscillator, and a bus line connecting these components, a D/A converter to convert a digital signal outputted from the CPU to an analog signal, and a drive circuit where there is adopted a known system that a plurality of maps for control gain calculation, pressure calculation process steps and control signal output steps are in advance stored in the memory apparatus such as the ROM as a program.

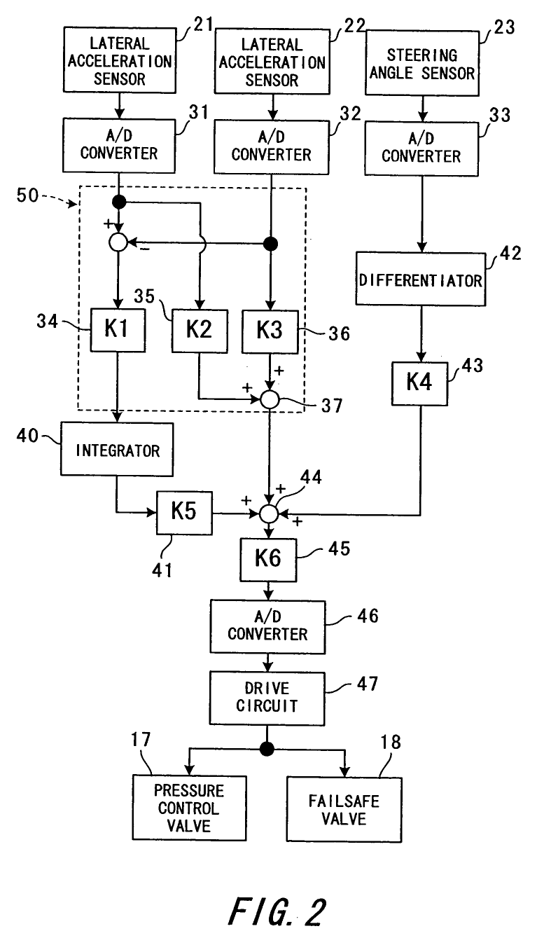

FIG. 2 is a control block diagram showing the construction of the controller 20.

FIG. 2 shows A/D converters 31, 32, and 33 each of which converts an analog voltage signal from each of the lateral acceleration sensors 21, 22 and the steering angle sensor 23 to a digital signal. A multiplier 34 calculates a roll angular acceleration φ by multiplying by a coefficient K1 a value obtained by subtracting a lateral acceleration GLb outputted from the lateral acceleration sensor 22 from a lateral acceleration GLa outputted from the lateral acceleration sensor 21. And a multiplier 35 multiplies the lateral acceleration GLa by a coefficient K2. Further, a multiplier 36 multiplies the lateral acceleration GLb by a coefficient K3, and an adder 37 calculates an actual lateral acceleration GL actually acting on the vehicle body by adding an output value of the multiplier 35 to an output value of the multiplier 36.

In a calculation process section 50 formed of the multipliers 34-36 and the adder 37, a calculation to separate each of the lateral accelerations GLa, GLb detected by the lateral acceleration sensors 21, 22 into the actual lateral acceleration GL actually acting on the vehicle body and the roll angular acceleration φ is thus performed. Note that this calculation process will be explained in detail later.

Further, an integral section (integrator) 40 integrates a value outputted from the multiplier 34, namely calculates a roll angular velocity ω from the roll angular acceleration Φ and a multiplier 41 multiplies an output value of the integral section 40 by a gain K5.

A differential section (differentiator) 42 differentiates a steering angle outputted from the steering angle sensor 23 and a multiplier 43 multiplies a value outputted from the differential section 42 by a gain K4.

And an adder 44 adds a value outputted from the adder 37, a value outputted from the multiplier 41, and a value outputted from the multiplier 43. A multiplier 45 multiplies a value outputted from the adder 44 by a gain K6.

The value outputted from the multiplier 45 finally corresponds to a pressure which should be applied to one of the pressure chambers in the actuators 2f, 2r and the calculated pressure control signal is inputted to a drive circuit 47 to drive each solenoid via a D/A converter 46. The pressure control valve 17 and the failsafe valve 18 are controlled by a signal from the drive circuit 47 to adjust a torsion force of each stabilizer 1f, 1r, so that a control to restrain the roll of the vehicle body is performed. Note that a control signal from the drive circuit 47 is adapted to allow supply or supply stop of a pressure and adjustment of a supply pressure to each actuator 2f, 2r and the calculated pressure signal has a positive and negative signs. The sign determines which pressure chamber should have an increase in pressures of the actuators 2f, 2r.

Note that the gain K5 is mapped to change with an output result of the integral section 40 and the other gains K4, K6 are likewise mapped to change with an output result of each of the differential section 42 and adder 44, which are stored in the memory apparatus such as the ROM in advance. It is assumed that each of the gains K4, K5, k6 is set to be optimal for characteristics of a vehicle on which the roll control apparatus is mounted.

Next, a calculation theory for separating and calculating actual lateral acceleration GL and roll angular acceleration ω acting on the vehicle body 100 based upon outputs of the lateral acceleration sensors 21 and 22 will be explained.

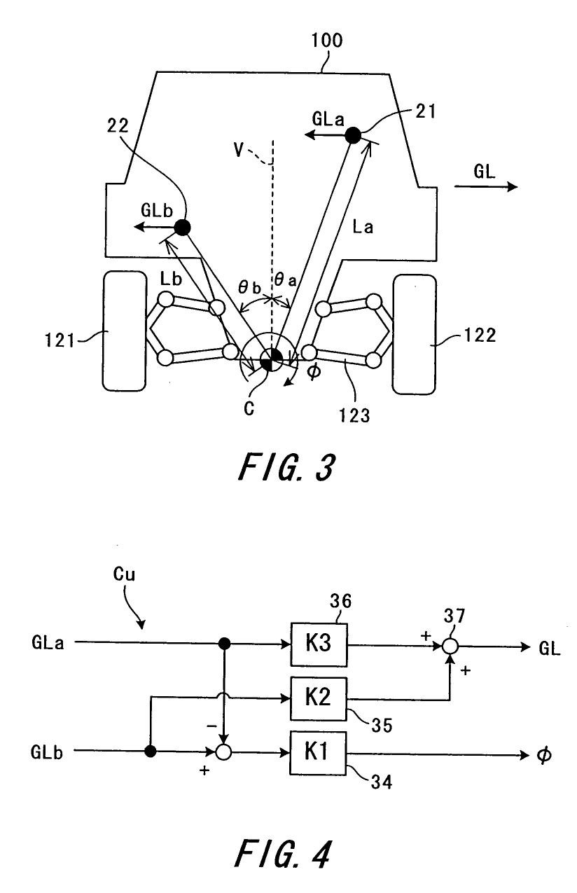

As shown in FIG. 3, each of the lateral acceleration sensors 21, 22 is located at any one of two positions on the vehicle body 100, each having a different distance from a roll center C and lateral acceleration acting on the vehicle body 100 is detected at each position. Note that wheels 121, 122 are supported to the vehicle body 100 via a suspension link 123.

In the preferred embodiment, the lateral acceleration sensor 21 is located to be at a position higher than at a position of the lateral acceleration sensor 22 in FIG. 3 and the lateral acceleration sensors 21, 22 are disposed on the same plane or substantially on the same plane dividing the vehicle body 100 into the front and rear sides.

Now it is assumed that the vehicle body 100 rolls around a roll axis with angular acceleration ω, receiving lateral acceleration GL generated during vehicle cornering the same as at the time when the vehicle runs on a corner.

In this case each lateral acceleration sensor 21, 22 detects each lateral acceleration GLa, GLb at each located position and each lateral acceleration GLa, GLb includes mixing of a component by the lateral acceleration GL and a component by the roll angular acceleration φ acting centering the roll center by the vehicle body rolling.

In FIG. 3, a distance between the roll center C (a roll axis of the vehicle body) of the vehicle body and the lateral acceleration sensor 21, namely a length of a linear line connecting both is set as La, an intersection angle by a vertical line V from the roll center C to an upward side in FIG. 3 and the linear line La is set as θa and a distance from the roll center C to the lateral acceleration sensor 22, namely a length of a linear line connecting both is set as Lb, and an intersection angle by a vertical line V and the linear line Lb is set as θb. Assuming that the actual lateral acceleration GL is positive when it is directed in the right direction in FIG. 3 and likewise, the roll angular acceleration φ is positive when it is directed in the clockwise direction, the following equation is established.

Each lateral acceleration GRa, GRb generated by the vehicle body roll at each position of the lateral acceleration sensors 21, 22:
GRa=La×ω×cos θa (1)
GRb=Lb×ω×cos θb (2)

Since each lateral acceleration GLa, GLb detected by each lateral acceleration sensor 21, 22 contains the actual lateral acceleration GL and the lateral accelerations GRa, GRb by the roll, the detected lateral accelerations GLa, GLb:
GLa=GL−GRa (3)
GLb=GL−GRb (4)

However, in FIG. 3, the direction of each of the roll lateral accelerations GRa, GRb is opposite to the direction of the actual lateral acceleration GL, the sign of the actual lateral acceleration GL is different from that of the each roll acceleration GRa, GRb.

Since a detection value GLa, an angle θa, and a length La of the lateral acceleration sensor 21 and a detection value GLb, an angle θb, and a length Lb of the lateral acceleration sensor 22 are found, the roll angular acceleration ω and the actual lateral acceleration GL are shown according to the above (1)-(4) equations based upon these values as follows.

Namely the roll angular acceleration φ:
φ=(GLb−GLa)/(La×cos θa−Lb×cos θb) (5)

The actual lateral acceleration GL:
GL=[Lb×cos θb/(La×cos θa−Lb×cos θb)]×GLa+[La×cos θa/(La×cos θa−Lb×cos θb)]×GLb (6)

Thus the actual lateral acceleration GL and the roll angular acceleration φ can be separated from the lateral accelerations GLa, GLb detected by the two lateral acceleration sensors 21, 22 for calculation.

Herein each coefficient K1, K2, and K3 in the calculation process section 50 will be defined by the constants La, Lb, θa, θb as follows.
K1=1/(La×cos θa−Lb×cos θb)
K2=La×cos θa/(La×cos θa−Lb×cos θb)
K3=Lb×cos θb/(La×cos θa−Lb×cos θb)

The roll angular acceleration φ extracted according to the equation (5) using these coefficients K1-K3 as follows:
φ=(GLb−GLa)×K1 (7)

The actual lateral acceleration GL extracted according to the equation (6):
GL=GLa×K3+GLb×K2 (8)

Accordingly in the calculation process section 50 as shown in FIG. 4, the actual lateral acceleration GL and the roll angular acceleration φ can be separated and calculated by multiplying each lateral acceleration GLa, GLb detected by the two lateral acceleration sensors 21, 22 by the coefficients K1, K2, K3.

Herein the roll center C is an intersection point between a line connecting an instantaneous rotation center of the right suspension link and a ground point of a wheel and a line connecting an instantaneous rotation center of the left suspension link and a ground point of a wheel. Therefore, in general a change of a roll angle of the vehicle causes each of the instantaneous rotation centers in the right and left suspension links to move, thereby moving the roll center C further in the upper and lower directions, and the right and left directions by comparing with when the vehicle does not roll.

As a result, the distances between the roll center C and two lateral acceleration sensors 21, 22, namely a length La and a length Lb change with the change of the roll angle. However, since, as described above, the location of the lateral acceleration sensor 21 is positioned higher than the lateral acceleration sensor 22 and the difference between the length La and the length Lb is in advance set, the calculations of the actual lateral acceleration GL and the roll angular acceleration φ does not become impossible even by the movement of the roll center C.

As described above, each lateral acceleration GLa, GLb detected by each lateral acceleration sensor 21, 22 includes lateral acceleration depending on the actual lateral acceleration GL and the roll angular acceleration φ, and the lateral acceleration depending on the roll angular acceleration φ becomes the greater as the difference between the length La and the length Lb becomes the greater. When the difference between the length La and the length Lb is large to some degree, an influence by the movement of the roll center C, namely a variation difference component of the actual lateral acceleration GL caused by the change of each of the length La and the length Lb can be reduced.

In a practical use, the location of the lateral acceleration sensor 21 may be positioned higher by equal to or more than 250 mm than the location of the lateral acceleration sensor 22. That is, in a case where the difference between the locations in the upper and lower directions is equal to or more than 250 mm in an ordinary passenger car, the difference between a calculated actual lateral acceleration and a real lateral acceleration can be sufficiently reduced. Accordingly performing a roll control based upon the calculated actual lateral acceleration provides a control without a practical problem.

And a real lateral acceleration generated during the turning of a vehicle is generated with a time lag between the front and rear sides of the vehicle body 100 because of some lengths of the vehicle body 100 between the front and rear sides. Accordingly, as the preferred embodiment, the lateral acceleration sensors 21, 22 are preferably positioned on the same plane or substantially on the same plane to divide the vehicle body 100 into the front and rear sides.

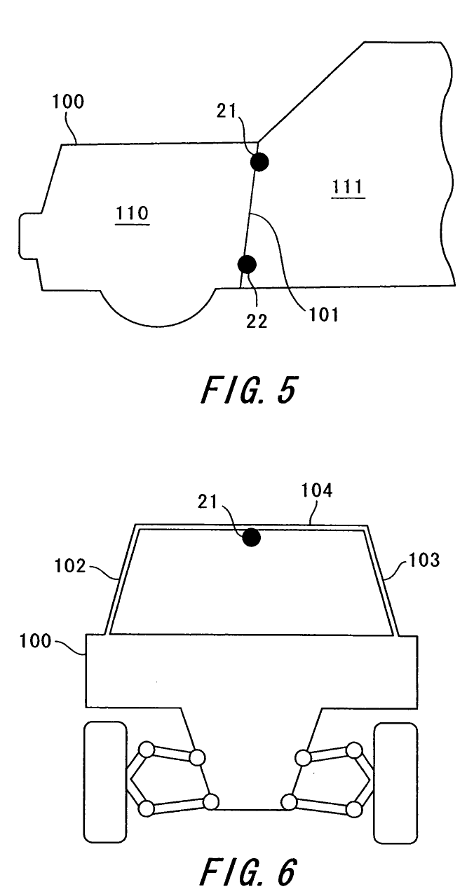

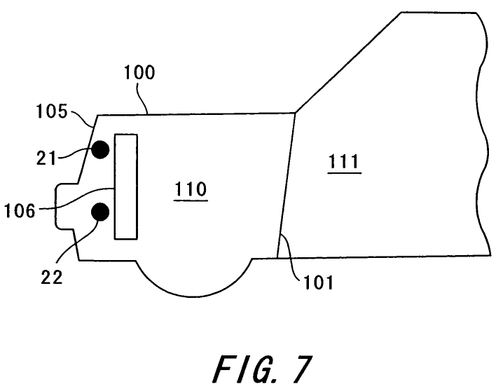

In detail, each mounting position of the lateral acceleration sensors 21, 22, as shown in FIG. 5-FIG. 7, may be in a bulk head 101 to divide a vehicle into an engine room 110 and a vehicle compartment 111 or a mounting position of at least one of the lateral acceleration sensors 21, 22 may be a frame 104 connecting the right and left pillars 102, 103 of the vehicle or between a front grill 105 and a radiator 106 of the vehicle.

In the case of mounting the lateral acceleration sensors 21, 22 to the bulk head 101, the bulk head 101 is substantially within the plane dividing the vehicle into the front and rear sides and further, the difference between the length La and the length Lb is secured. On the other hand, in the case of mounting one of the lateral acceleration sensors 21, 22 to the frame 104, since the frame 104 is disposed in the highest position in the vehicle, it is easier to increase the difference between the length La and the length Lb. Further, in the case of mounting one of the lateral acceleration sensors 21, 22 between the front grill 105 and the radiator 106, a space between the front grill 105 and the radiator 106 is substantially within the plane dividing the vehicle into the front and rear sides and further, the difference between the length La and the length Lb can be secured. Accordingly in these cases, the actual lateral acceleration can be more accurately calculated.

As described above, in the above-mentioned control apparatus and control method, it is possible to separate the actual lateral acceleration GL from the roll angular acceleration φ and as a result, the roll control can be performed based upon the actual lateral acceleration GL.

That is, unlike the conventional apparatus, the roll control can be performed based upon an actual lateral acceleration. Therefore, for example, when a vehicle is yawed caused by disturbances such as crosswinds the vehicle receives while going straight or when a steering wheel is switched to be steered into the different direction, since a time lag in the movement of the roll is generated to the actual lateral acceleration GL, even if the direction of the lateral acceleration GLa detected by the lateral acceleration sensor 21 is opposite to the direction of the lateral acceleration GLb detected by the lateral acceleration sensor 22, for example when the direction of the actual lateral acceleration GL of the vehicle body 100 is different from the roll direction of the vehicle body 100, a proper roll control can be performed.

According to the conventional apparatus, in this case the direction of the roll angular acceleration φ becomes opposite to the direction of the lateral acceleration to be detected. Namely since the detected lateral acceleration becomes smaller than the actual lateral acceleration GL, or in an extreme case the direction of the detected lateral acceleration becomes opposite to the direction of the actual lateral acceleration GL, there is a case where a control to promote the roll is performed. Such control can be prevented in the preferred embodiment.

Note that in the above-described embodiment, each of the lateral acceleration sensors 21, 22 is disposed substantially within the plane dividing the vehicle body 100 into the front and rear sides and is positioned separately in the upper and lower directions, but as long as the lateral acceleration can be basically detected in equal to or more than two positions in the vehicle body 100, the actual lateral acceleration GL can be separated. However, there is a case where the separation is not performed depending on the position of the roll center C. Therefore, it is preferable that even if the roll center C changes, the lateral acceleration sensors 21, 22 are located so that each distance of the lateral acceleration sensors 21, 22 to the changed roll center C is different with each other.

In the preferred embodiment, the lateral acceleration is detected in two locations of the vehicle body 100 using two lateral acceleration sensors 21, 22, but the lateral acceleration may be detected in more than two locations. Further, since the roll control in the preferred embodiment basically requires the actual lateral acceleration GL, the lateral acceleration of the vehicle body 100 is detected, but the velocity in the lateral direction of the vehicle body 100 can be detected by integrating the lateral acceleration.

Further, changes of the roll center C depending on a roll angle of the vehicle body 100 are in advance stored in the memory apparatus of the controller 20 and a correction calculation by each coefficient K1, K2, K3 is performed as needed. As a result, an accurate actual lateral acceleration can be calculated all the time.

Next, a roll control of a vehicle performed in the roll control apparatus 19 will be explained based upon a calculation value of the actual lateral acceleration or the roll angular acceleration.

First, in FIG. 1, when a vehicle is running straight and there is no detection signal from the lateral acceleration sensors 21, 22 and the steering angle sensor 23, the controller 20 maintains the pressure control valve 17 to be in the neutral position without applying the current to each solenoid of the pressure control valve 17 and maintains the failsafe valve 18 to be in the communicating position by applying the current to the solenoid of the failsafe valve 18.

When each value of the lateral acceleration and the steering angle is zero, each sensor 21, 22, 23 outputs a voltage signal that the each value of the lateral acceleration and the steering angle is zero. Accordingly, since the signal “zero” is inputted to all of the multiplier 34, the multiplier 35, the multiplier 36, and the differentiator 42, as a result the signal “zero” is outputted to the drive circuit 47. Note that the drive circuit 47 is in advance designed not to apply the current to the solenoids of the pressure control valve 17 and apply the current to the solenoid of the failsafe valve 18 to be maintained in the communicating position in a case where the signal is zero.

Note that the current is applied to the solenoid of the failsafe valve 18 constantly during vehicle running to maintain the failsafe valve 18 to be always in the neutral position during the vehicle running.

As the pressure control valve 17 is maintained to be in the neutral position, the hydraulic oil to be supplied to each actuator 2f, 2r becomes in an unloaded state and each of the actuators 2f, 2r is maintained to be in a communicating state. Accordingly the actuators 2f, 2r can move freely to make the stabilizers 1f, 1r to be in a free state, maintaining a good ride comfort in a vehicle.

On the other hand, when a driver in a vehicle operates a steering wheel to turn the vehicle, lateral acceleration is generated in the vehicle body 100. The lateral acceleration sensors 21, 22 detect a magnitude of the lateral acceleration to input a voltage signal corresponding to the magnitude to the controller 20. And the steering angle sensor 23 detects an operation amount of the steering wheel to input a voltage signal corresponding to the detected operation amount to the controller 20.

An output of each lateral acceleration sensor 21, 22 is separated into the actual lateral acceleration GL and the roll angular acceleration φ at the calculation process section 50 and the actual lateral acceleration is inputted to the adder 44 as it is and on the other hand, the roll angular acceleration φ is inputted to the integral section (integrator) 40 to be converted into the roll angular velocity ω and further, a predetermined gain K5 is multiplied to the roll angular velocity ω at the multiplier 41 to be inputted to the adder 44.

And a voltage signal outputted from the steering angle sensor 23 is converted into a steering angular velocity at the differentiator 42 and further, a gain K4 is multiplied to the converted steering angular velocity at the multiplier 43 to be inputted to the adder 44.

A signal outputted from the adder 44 adding each input is multiplied by a predetermined gain K6 at the multiplier 45 to be a control signal, which is inputted into the drive circuit 47 via the D/A converter 46.

The drive circuit 47 outputs a control signal to the pressure control valve 17 to generate a pressure for restraining the roll and the current is applied to the solenoid of the pressure control valve 17. Thereby the pressure control valve 17 is switched and the pressure corresponding to a calculation value for the roll restraining is supplied to one side of each port 10f, 10r, 11f, 11r of the actuators 2f, 2r of the stabilizers 1f, 1r/

This operates the actuators 2f, 2r and a roll moment in the opposing direction against the actual lateral acceleration GL acting on the vehicle body 100 by a centrifugal force is basically applied to the vehicle body 100 by the stabilizers 1f, 1r. Namely a torsion force of the stabilizers 1f, 1r is increased to restrain the roll generated in the vehicle body 100 effectively.

Since the actual lateral acceleration GL as a variation factor of the pressure calculated for controlling the actuators 2f, 2r serves to roll the vehicle body 100 by the vehicle turning, generating the moment in the actuators 2f, 2r in the direction against this roll direction allows to increase the torsion force of the stabilizers 1f, 1r, which can restrain the roll. Accordingly the actual lateral acceleration GL is thus taken in the above calculation mainly for restraining the roll.

On the other hand, the reason why the roll angular velocity ω is taken in as the variation factor of the pressure is that the roll vibration is damped by this factor. Namely a moment is generated in each actuator 2f, 2r in the direction for reducing the roll velocity to operate the stabilizer apparatus 5 as a damper to the roll. And the reason why the steering angular velocity is taken in is that immediately after the steering operation is performed, an initial roll is generated due to a delay of generation of the actual lateral acceleration GL to the actual steering operation, but the torsion force of the stabilizers 1f, 1r can be increased before the generation of the actual lateral acceleration by considering the steering angular velocity to prevent the initial roll.

The actual lateral acceleration GL directed in the right direction in FIG. 3 means a positive value, and the roll angular velocity ω and the steering angular velocity to roll the vehicle body 100 in the clockwise direction mean a positive value. In detail, for example when a vehicle is turning in one direction, the vehicle is steered with the steering angular velocity so as to roll the vehicle body 100 in the clockwise direction in FIG. 3 to exert the actual lateral acceleration GL in the right direction on the vehicle body 100. When the vehicle body 100 rolls with the roll angular velocity ω in the clockwise direction, the signs of all variation factors become positive. In this case, all factors are added by the adder 44. Accordingly the mixing controls for restraint of the roll based upon the actual lateral acceleration GL, restraint of an initial roll by the steering angular velocity, and reduction (roll damping) of the roll angular velocity ω based upon the roll angular velocity ω are performed, thereby to perform an accurate roll control, which can not be achieved by the conventional control apparatus.

On the other hand, in a case where in FIG. 3, the actual lateral acceleration GL in the right direction acts on the vehicle body 100, the vehicle body 100 rolls with the roll angular velocity ω in the counter clockwise direction, and the vehicle is steered with the steering angular velocity in such a away so as to roll the vehicle body 100 in the clockwise direction, namely when the vehicle is steered during the turning of the vehicle, only a value of the roll angular velocity ω becomes negative, and at the adder 44, a value obtained by multiplying the roll angular velocity ω by a gain K5 is subtracted. In this case, the restraint of the roll based upon the actual lateral acceleration GL, restraint of an initial roll by the steering angular velocity, and reduction of the roll angular velocity ω are performed, thereby to prevent an increase in the roll generated when the roll direction is opposite to the lateral acceleration direction during the turning of the steering wheel, which can not be achieved by the conventional control apparatus. And an initial roll is prevented in consideration of the roll damping after the turning of steering wheel, and since the roll generated in a delay to the actual lateral acceleration GL after the turning of the steering wheel is restrained based upon the actual lateral acceleration GL, also in this respect there is no problem with roll restraint lack occurring after the turning of the steering wheel.

When a vehicle is yawed by crosswinds during the vehicle going straight, for example in a case where the actual lateral acceleration GL in the right direction exerts on the vehicle body 100 in FIG. 3, the vehicle body 100 rolls with the roll angular velocity ω in the counter clockwise direction, and the steering angular velocity is zero with the steering wheel maintained in the neutral position, the steering angular velocity is zero, the actual lateral acceleration GL has a positive value, a value of the roll angular velocity ω is negative, and at the adder 44, a value obtained by multiplying the roll angular velocity ω by a gain K5 is subtracted from the actual lateral acceleration GL.

In this case, since the roll in the clockwise direction is actually restrained by the actual lateral acceleration GL generated in a delay to the roll generation, the roll generated by the crosswinds is restrained by the roll damping to reduce the roll angular velocity ω, an increase in the roll generated when the roll direction is opposite to the direction of the lateral acceleration in the vehicle body 100 in the case of receiving the crosswinds can be prevented. In this regard, in the conventional control apparatus the lateral acceleration to be detected by the lateral acceleration sensor is excessively small or the direction of the actual lateral acceleration GL is recognized to be opposite in some cases. Accordingly in a case where the vehicle body 100 rolls in the clockwise direction after it rolls in the counter clockwise direction, the roll restraint is not sufficient, thereby to increase the roll. In the apparatus in the preferred embodiment, however, the roll can be restrained by the actual lateral acceleration GL obtained by separating the detected lateral acceleration from the roll angular acceleration φ. Therefore, even in a situation where the direction of the roll turns, the roll can be properly restrained.

That is, according to the preferred embodiment, since an increase in the roll can be prevented even when the roll direction of the vehicle body 100 is opposite to the direction of the actual lateral acceleration GL as described above, a driver has no uncomfortable feeling, at the same time providing stability of the behavior of the vehicle body 100.

And in the roll control, roll damping is possible by taking the roll angular velocity ω in the calculation. However, since it is possible to recognize roll frequencies from the roll angular velocity ω, the roll angular velocity ω is feedback-controlled to change a natural frequency of the roll. This means that in a case where an external frequency input is within a resonance frequency region of the roll, it is possible to change the resonance frequency of the roll, and an amplification of the roll vibration can be prevented without a fail, further stabilizing a posture of the vehicle.

Note that even if the roll control is performed based upon only the actual lateral acceleration GL, it is possible to prevent an increase in the roll after the vehicle is steered, or the vehicle receives crosswinds as described above, and since the direction of the roll angular acceleration φ is recognized, not only the roll after the vehicle is steered or the vehicle receives the crosswinds, but also a roll increase during the vehicle turning can be prevented by properly setting a gain by which the actual lateral acceleration GL is multiplied, based upon the direction of the roll angular acceleration φ and the direction of the actual lateral acceleration GL.

Further, if not only the roll angular velocity ω but also the roll angle α are calculated by setting an integral section integrating the roll angular velocity ω at the calculation process section 50, and the roll angle α is taken into the pressure calculation, it is possible to perform the roll control with the roll angle α feedbacked. Namely since in this case the roll frequency can be recognized the same as when the roll angular velocity ω is feedback-controlled, amplification of the roll vibration can be prevented.

Namely in the roll control apparatus in the preferred embodiment, when the vehicle is back to a normal running state, such as where the vehicle goes straight again after the vehicle turns, since the lateral acceleration detected by each lateral acceleration sensor 21, 22 becomes zero and the steering amount detected by the steering angle sensor 23 becomes zero, the pressure control valve 17 is switched to the previous switching position to make the stabilizers 1f, 1r be in a free state and the hydraulic source 16 be in unloaded state.

Note that in case the emergence situation of the control occurs, since the failsafe valve 18 becomes in a closed position by cutting power supply to the solenoid of the failsafe valve 18, the ports 10f, 10r, 11f, 11r of the actuators 2f, 2r are blocked by the failsafe valve 18 and at least the stabilizers 1f, 1r perform a usual operation to restrain the roll of the vehicle body 100.

And the hydraulic source 16 is simultaneously maintained in an unloaded state by the failsafe valve 18 to achieve an energy saving effect and a failsafe effect.

In the preferred embodiment, a rotary actuator is used as each of the actuators 2f, 2r, but a cylinder actuator equipped with two opposing pressure chambers may be connected to one end of each stabilizer disposed in the front and rear wheels of a vehicle (not shown).

1. A detection apparatus of a roll control signal for a vehicle, comprising:
at least two lateral acceleration detectors located at different positions of a vehicle body to detect lateral acceleration acting on the vehicle body; and
a calculator to separate and calculate actual lateral acceleration acting on the vehicle body by a centrifugal force, and roll angular acceleration acting on the vehicle body around the roll center based upon a distance from a roll center of the vehicle body to each of the detectors, an intersection angle of each line connecting each of the detectors and the roll center, and outputs of the detectors.

2. The detection apparatus according to claim 1, wherein:
the calculator calculates roll angular velocity based upon the roll angular acceleration.

3. The detection apparatus according to claim 1, wherein:
the calculator in advance stores a change of the roll center in accordance with a roll angle of the vehicle body, and corrects the actual lateral acceleration and a calculation value of the roll angular acceleration based upon the change.

4. The detection apparatus according to claim 1, wherein:
the each of the detectors is located at positions, each position having a different distance from the roll center of the vehicle body.

5. The detection apparatus according to claim 3, wherein:
the each of the detectors is located at different positions in the upper and lower directions.

6. The detection apparatus according to claim 3, wherein:
the each of the detectors is located at positions spaced by equal to or more than 250 mm from each other in the upper and lower directions of the vehicle body.

7. The detection apparatus according to claim 1, wherein:
the each of the detectors is located on the same plane or substantially on the same plane dividing the vehicle body into the front and rear sides.

8. The detection apparatus according to claim 1, wherein:
the each of the detectors is located in a bulk head dividing the vehicle into an engine room and a vehicle compartment.

9. The detection apparatus according to claim 1, wherein:
at least one of the detectors is located in a frame connecting a right and a left pillar of the vehicle body.

10. The detection apparatus according to claim 1, wherein:
the each of the detectors is located between a front grill and a radiator of the vehicle.

11. A detection method of a roll control signal for a vehicle, comprising the steps of:
detecting lateral acceleration acting on a vehicle body from at least two lateral acceleration detectors located at different positions of the vehicle body; and
calculating actual lateral acceleration acting on the vehicle body by a centrifugal force, and roll angular acceleration acting on the vehicle body around the roll center based upon a distance from a roll center of the vehicle body to each of the detectors, an intersection angle of each line connecting each of the detectors and the roll center, and outputs of the detectors.

12. The detection method according to claim 11, wherein:
the calculation step calculates the roll angular velocity by integrating the roll angular acceleration.

13. A stabilizer apparatus for controlling roll of a vehicle, comprising:
a torsion bar to connect a right and a left wheel of the vehicle;
an actuator to provide a torsion force to the torsion bar by a hydraulic pressure;
a hydraulic control device to control the hydraulic pressure supplied to the actuator;
at least two lateral acceleration sensors disposed at different positions of a vehicle body to detect lateral acceleration acting on the vehicle body;
a calculator to separate and calculate actual lateral acceleration acting on the vehicle body by a centrifugal force, and roll angular acceleration acting on the vehicle body around the roll center based upon a distance from a roll center of the vehicle body to each of the detectors, an intersection angle of each line connecting each of the detectors and the roll center, and outputs of the detectors; and
a drive control device to control the hydraulic control device for restraining roll of the vehicle body based upon the actual lateral acceleration calculated by the calculator and the lateral acceleration.

14. The stabilizer apparatus according to claim 13, wherein:
the drive control device controls the roll of the vehicle body by adjusting the torsion force of the torsion bar by the actuator based upon the actual lateral acceleration and roll angular velocity.

15. The stabilizer apparatus according to claim 13, wherein:
the drive control device damps the roll of the vehicle body by the actuator based upon the roll angular velocity.
